(19) United States
(12) Patent Application Publication
(10) Pub. No.: US 2015/0309593 A1
(43) Pub. Date: Oct. 29, 2015

(54) KEYBOARD

(71) Applicant: Larry Kassel, Flint, MI (US)

(72) Inventor: Larry Kassel, Flint, MI (US)

(21) Appl. No.: 14/698,525

(22) Filed: Apr. 28, 2015

Related U.S. Application Data
(60) Provisional application No. 61/984,913, filed on Apr. 28, 2014.

(51) Int. Cl. G06F 3/023; G06F 3/0489; G06F 3/0484; G06F 3/041; G06F 3/0481

(52) U.S. Cl. CPC G06F 3/0236; G06F 3/0412; G06F 3/0416; G06F 3/04817; G06F 3/04842; G06F 3/0489; G06F 2203/04803

(57) ABSTRACT

Disclosed is a computing device for use with touch input used by a user to input alphanumeric characters to the computing device. Included is a computing device made up of an electronic control unit in communication with a touch input device and a display screen. A database is stored in the electronic control unit. The database contains basic shape combinations correlated with alphanumeric characters. To input the basic shape combination, a user touches a basic shape, and slides to another basic shape. The computing device correlates the basic shape combination with an alphanumeric character. The electronic control unit is additionally configured to define a first border profile for each zone with a basic shape and to determine when a user is touching one of the zones and to change the first border profile to a second border profile for the zones adjacent the zone being touched by the user.

### CROSS-REFERENCE TO RELATED APPLICATIONS

This application claims priority of U.S. Provisional Application 61/984,913 filed Apr. 28, 2014, the contents of which are incorporated herein by reference.

### FIELD OF THE INVENTION

The present invention is directed to a computing device, specifically a computing device for use with touch input used by a user to input alphanumeric characters to the computing device.

### BACKGROUND OF THE INVENTION

Various systems and methods for inputting text characters into a computing device using a touch screen or physical keyboard are known. These systems and methods include traditional QWERTY style keyboards; traditional telephone T9 style keypads where a user repeatedly taps the number with the desired character until the desired character is input; software based handwriting recognition; and other methods. These keyboards are known to be software based, with the keyboard displayed on a touch screen display of a smart phone or other computing device. One such example is disclosed by U.S. Patent Application 2012/0242579 to Chua, incorporated herein by reference.

These keyboards and methods share common problems such as difficulties in fitting a full sized keyboard onto a small cell phone touch screen, difficulties with handwriting recognition software, difficulty in using traditional sized keyboard with one hand etc. As such, a new text input system and method is desired.

### SUMMARY OF THE INVENTION

The disclosed invention includes a computing device made up of an electronic control unit in communication with a touch input device and a display screen. A database is stored in the electronic control unit. The database contains basic shape combinations correlated with alphanumeric characters. The electronic control unit is configured to identify a plurality of zones on the touch input device. At least some of the zones are associated with a basic shape. The electronic control unit is further configured to determine when a user has input one of the basic shape combinations with the touch input device and identify from the database the alphanumeric character correlated with the input basic shape combination. The electronic control unit is also configured to instruct the display screen to display the correlated alphanumeric character. To input the basic shape combination, a user touches down in one of the plurality of zones, and slides to at least one more other zones of the plurality of zones before lifting up. The electronic control unit is additionally configured to define a first border profile for each zone of the plurality of zones. The electronic control unit is further configured to determine when a user is touching one of the plurality of zones and to change the first border profile to a second border profile for the zones adjacent the zone being touched by the user.

The disclosed invention may be performed to enter an alphanumeric character into a computing device with a method that includes: providing a database containing basic shape combination correlated with alphanumeric characters; displaying a plurality of basic shapes; selecting a combination of basic shapes of the displayed plurality of basic shapes; and identifying which alphanumeric character is associated with the selected combination of basic shapes.

### BRIEF DESCRIPTION OF THE DRAWINGS

FIG. 1 is an illustration of a smartphone including the disclosed invention;

FIG. 2 is an illustration of a traditional computer including the disclosed invention;

FIG. 3 is an illustration of a smart phone and smart watch including the disclosed invention;

FIG. 4 is an illustration of a schematic of a computing device;

FIG. 5 is an illustration of a plurality of zones and basic shapes;

FIG. 6 is an illustration of alphanumeric character and basic shape correlations;

FIG. 7 is an illustration of alphanumeric character and basic shape correlations;

FIG. 8 is an illustration of alphanumeric character and basic shape correlations;

FIG. 9 is an illustration of alphanumeric character and basic shape correlations;

FIG. 10 is an illustration of alphanumeric character and basic shape correlations;

FIG. 11 is an illustration of alphanumeric character and basic shape correlations;

FIG. 12 is an illustration of a plurality of zones and basic shapes;

FIG. 13 is an illustration of alphanumeric character and basic shape correlations;

FIG. 14 is an illustration of a plurality of zones and basic shapes;

FIG. 15 is an illustration of the creation of dead zones;

FIG. 16 is an illustration of the creation of dead zones; and

FIG. 17 is an illustration of a flowchart for a method of practicing the disclosed invention.

### DETAILED DESCRIPTION OF THE PREFERRED EMBODIMENTS

The disclosed embodiments provide both an apparatus and method for inputting text characters into a smartphone or other computing device without the need of a full size QWERTY keyboard. The apparatus and method utilize a set of basic shapes which may be combined in various ways to signal the input of an alphanumeric character. The embodiment uses only nine different shapes to enable the user to input the full English alphabet and combinations thereof, Arabic numerals, punctuation, as well as alphabets of other languages.

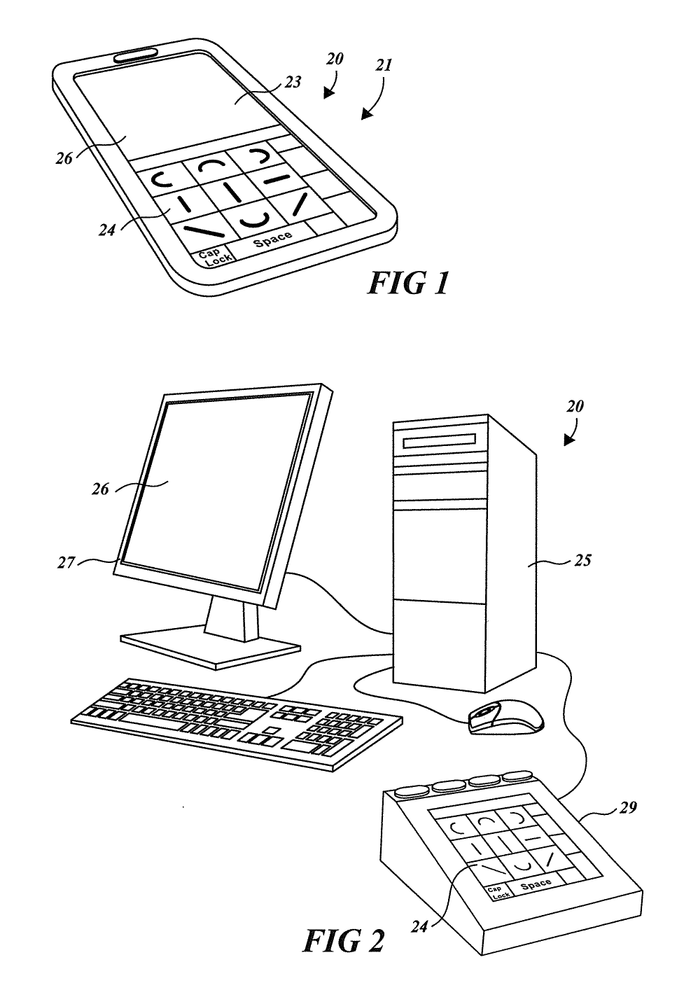

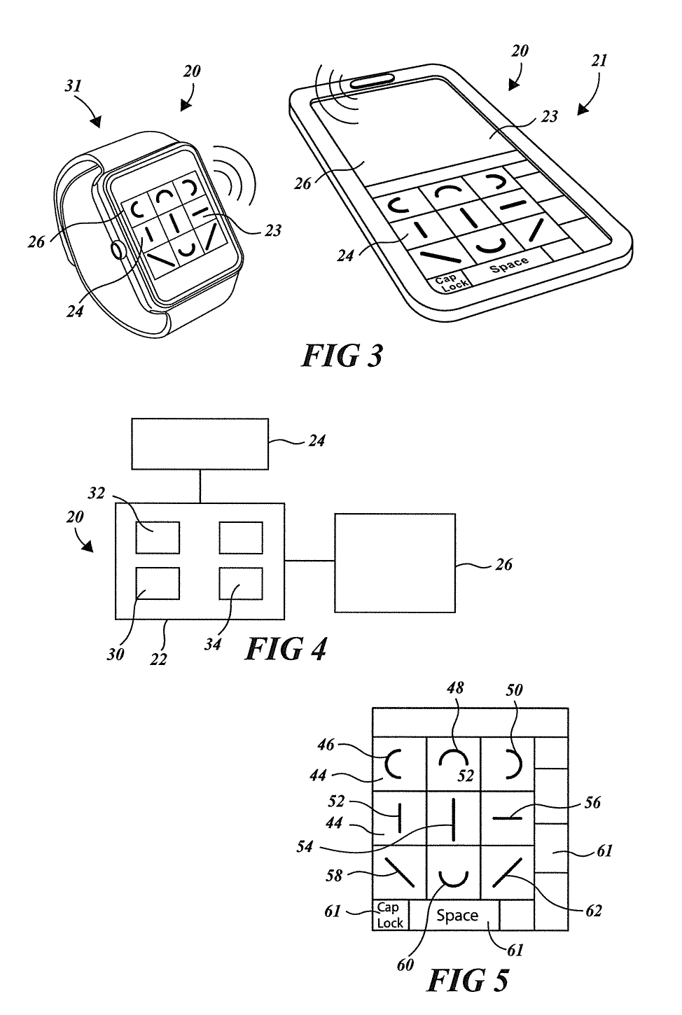

With reference now to FIGS. 1-4, a computing device 20 is shown. The computing device 20 includes an electronic control unit 22, a touch input device 24 in communication with the electronic control unit 22, and a display screen 26 in communication with the electronic control unit 22. One example of the computing device 20 includes a smartphone device 21, as shown in FIG. 1, where the touch input device 24 and the display screen 26 are incorporated into a touch screen display 23. Another example, as shown in FIG. 2, is a traditional personal computer 25 connected to a monitor 27 as the display screen 26 and separate user interface 29 as the touch input device 24. In a further example, as shown in FIG. 3, the computing device 20 may include multiple components that communicate wirelessly with each other such as a smart watch 31 that incorporates the touch input device 24 and the display screen 26 are incorporated into the touch screen display 23, the smart watch communicating wirelessly with the smartphone 21 by way of blue tooth or other means known to those skilled in the art, with the smartphone 21 housing the electronic control unit 22.

The electronic control unit 22 includes a non-transitory computer readable storage medium 30 for storing applications, software, databases, etc., a power source 32, and a processor. The software and applications stored on the storage medium enable configuration of the electronic control unit 22 as described herein.

A database of containing basic shape combinations correlated with alphanumeric characters is stored on the electronic control unit 22.

The electronic control unit 22 is configured to identify a plurality of zones on the touch input device 24 with each zone associated with a basic shape. The electronic control unit 22 is further configured to determine when a user has input one of the basic shape combinations with the touch input device 24 and identify from the database the alphanumeric character correlated with the input basic shape combination. The electronic control unit 22 is also configured to instruct the screen display 26 to display the correlated alphanumeric character.

With reference to FIG. 14, the plurality of zones is shown where the zones are defined by a series of generally pie shapes areas 38 arraigned in a circle. At the center of the generally pie shaped areas 38 arraigned in a circle is a dead zone 40. The dead zone 40 is not associated with any basic shape.

With reference to FIG. 5, the plurality of zones is shown where the zones are defined by a series of rectangle shaped areas 44 arraigned in a series of columns and rows.

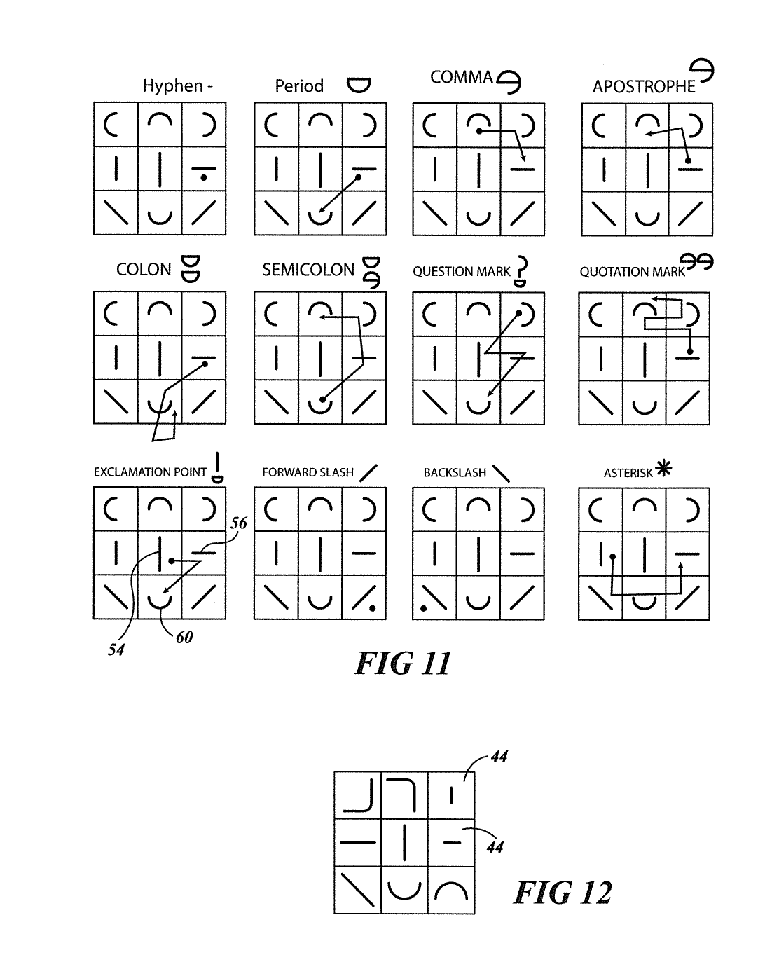

With reference now to FIGS. 5-11, the basic shapes of one embodiment include a right face half circle 46, a downward facing half circle 48, a left facing half circle 50, a short vertical line 52, a long vertical line 54, a horizontal line 56, a downward sloping line 58, and upward facing half circle 60, and an upward sloping ling 62. The basic shapes shown in FIGS. 5-11 are just a single example of shapes to be used. Other basic shapes may be utilized. An example of other basic shapes are shown in the rectangular shapes areas 44 of the zones in Fig. 12. Additional zones 61 may be identified by the electronic control unit 22. The additional zones 61 may be associated with other functions such as a space bar, caps lock, switching keyboard styles, etc. Not all rectangular shapes zones, triangular shapes zones, basic shapes, etc. in the Figs. have been specifically pointed out with reference numbers and lead lines. It is understood and appreciated that features that appear similar through the figures are similar in nature despite only one or a few have been specially pointed out.

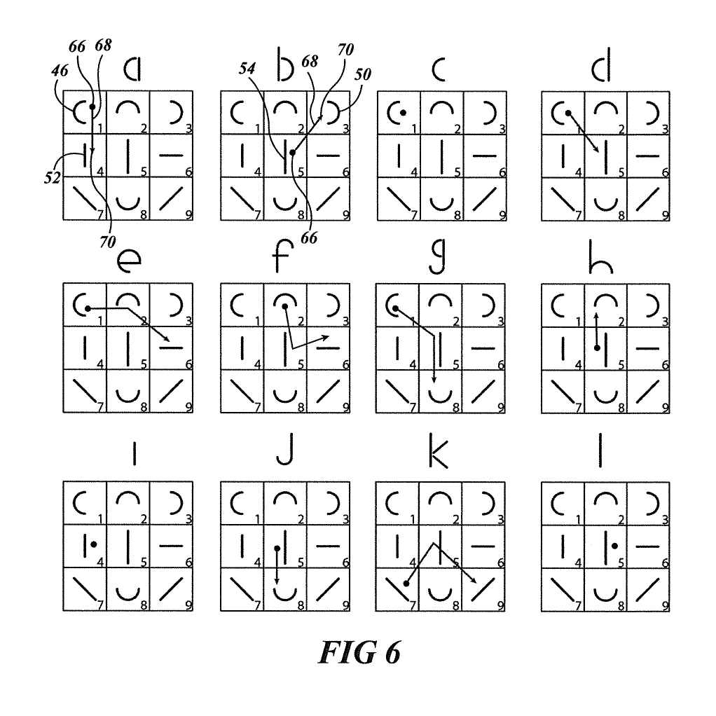

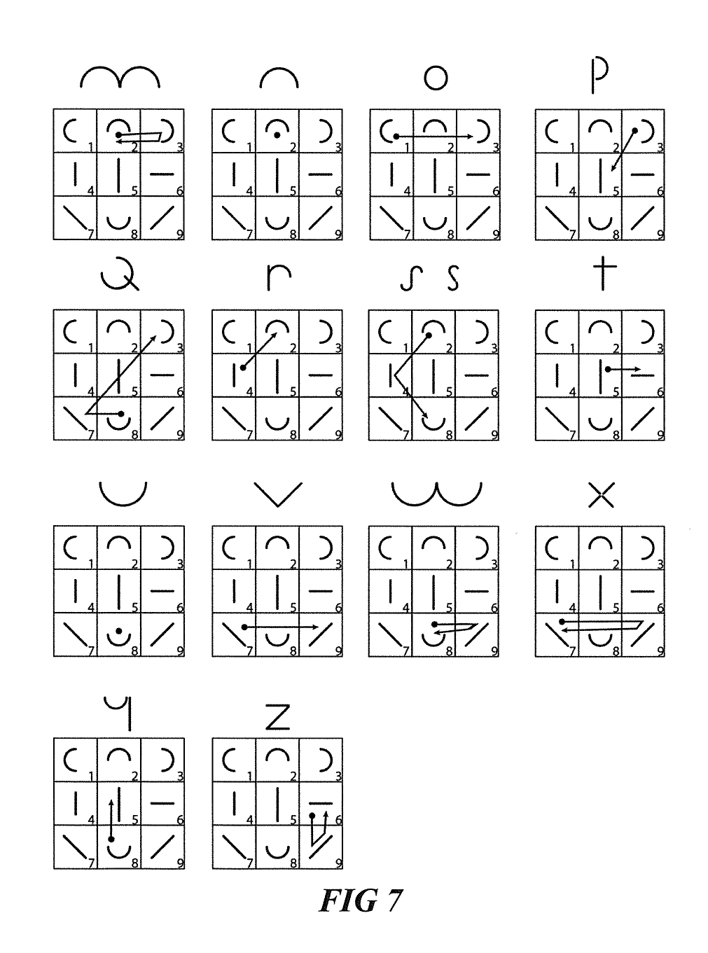

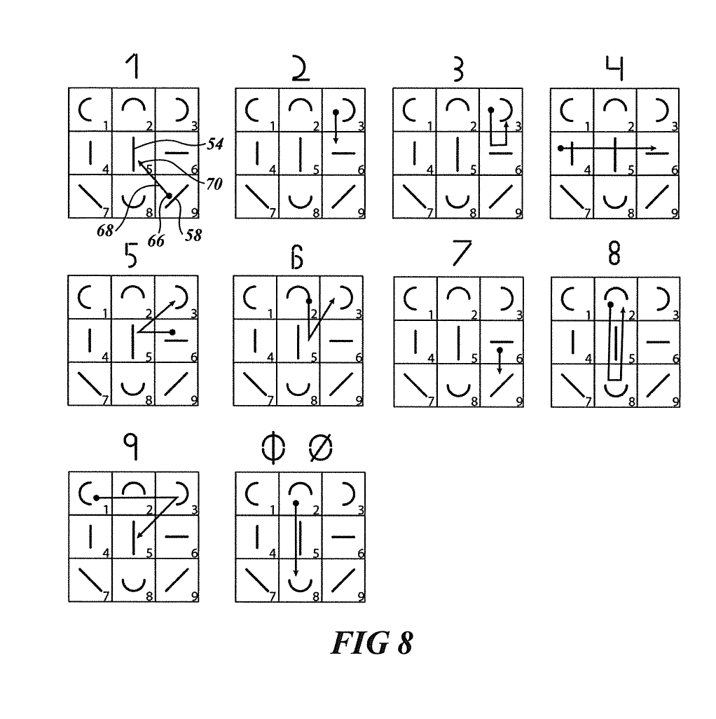

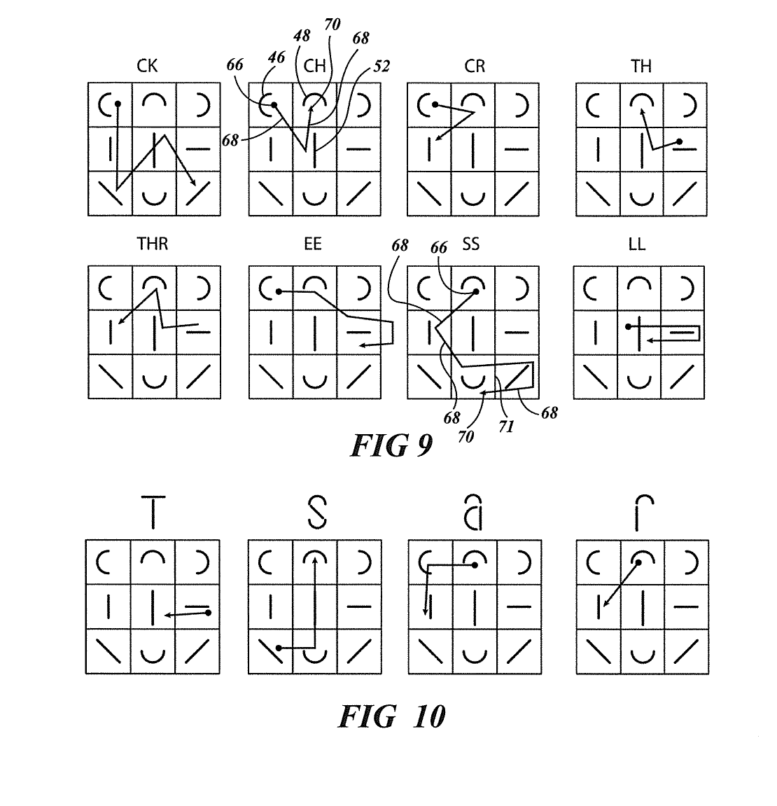

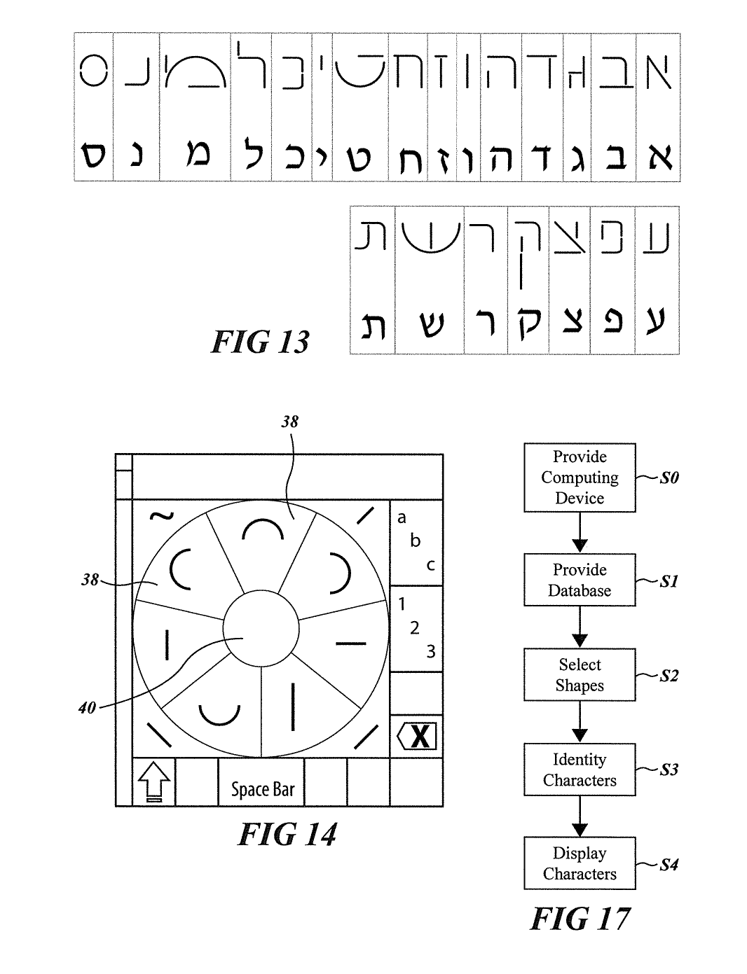

The database stored on the electronic control unit 22 contains correlation of basic shapes with alphanumeric characters. For example, the alphanumeric character “a” may be correlated with the combination of the right facing half circle 46 and the short vertical line 52, and the alphanumeric character “b” may be correlated with the combination of the long vertical line 54 and the left facing half circle 50. The full English alphabet correlated with various combination of basic shape is shown in FIGS. 6 and 7. In addition to traditional English letters, punctuation and numbers may be correlated with combinations of basic shapes. For example, as shown in FIG. 8, the alphanumeric character “1” may be correlated with the combination of the downward sloping line 58 and the long vertical line 54, and, as shown in FIG. 11, the alphanumeric character “!” may be correlated with combination of the long vertical line 54, the horizontal line 56 and the upward facing half circle 60. Further, non-English letters can be correlated in the database with combinations of basic shapes. For example, in FIG. 13 correlations of various Hebrew characters with combinations of the basic shapes of FIG. 12 are shown. Additionally, combinations of groups of alphanumeric characters may be correlated with combinations of basic shapes. For example, as shown in FIG. 9, the commonly used alphanumeric group “ch” may be correlated with combination of the right facing circle 46, the tall vertical line 52 and the downward facing half circle 48.

To input the combination of basic shapes, the user places their finger, or touches down, on the touch input device 24 in one of the plurality of zones. The user then slides their finger to one more other zone of the plurality of zones. The user continues to slide to other zones until every zone containing the desired basic shapes of the basic shape combination correlated with whatever alphanumeric character is desired by the user has be touched. The user then removes their finger, or lifts up, from the touch input device 24.

The input of various combinations of basic shapes by the user is illustrated in FIGS. 6-11. The user input is represented by an arrow. The arrow is made up of a starting point 66, a line 68 and an arrow head 70. The user touches down at the starting point 66, slides their finger though the various zones along the line 8, and lifts up at the arrow head 70. The arrows in FIGS. 6-11 disclose various combinations of basic shapes with alphanumeric characters and character groups. FIGS. 6, 7 and 10 discloses correlations of basic shapes with English letters. FIGS. 11 discloses correlations of basic shapes with punctuation marks. FIGS. 8 discloses correlations of basic shapes with Arabic numbers. FIGS. 9 discloses correlations of basic shapes with English letter groups. Not all input combination arrows, and their respective parts, in the Figs. have been specifically pointed out with reference numbers and lead lines. It is understood and appreciated that features that appear similar through the figures are similar in nature despite only one or a few have been specially pointed out.

Additionally, the electronic control unit 22 may be configured to recognize various gestures associated with specific actions. The electronic control unit 22 may by configured to instruct the display screen 26 to a second correlated alphanumeric character when the user slides out of one of the plurality of zones at a predetermined side 71 and then slides back into the one of the plurality of zones. For example, as shown in FIG. 9, a “ss” may be entered by first entering the downward facing half circle, the short vertical line, and the upward facing half circle, then, before lifting their finger, sliding out of the zone containing the upward facing half circle to the right at the predetermined side 71, then sliding back to the upward facing circle before finally lifting their finger.

To improve the performance of the computing device 20, the arraignment of the plurality of zones includes one or more dead zone 40. The dead zone 40 is an area not associated with any basic shape. The dead zones 40 help the user to more accurately input the desired basic shape combination by providing a path between zones to reduce the incidence of the user accidently touching adjacent zones associated with basic shapes that are not part of the desired basic shape combination. The dead zone 40 may be static in shape and location, or make be created as the user inputs basic shapes by altering the shape and/or location of some of the zones of the plurality of zones in real time.

To create the dead zones 40, the electronic control unit 22 is configured to define a first border profile for the each of the zones of the plurality of zones. The electronic control unit 22 is further configured to determine when the user is touching one of the zones of the plurality of zones, and to change the first border profile to a second border profile for the zones adjacent the zone being touched.

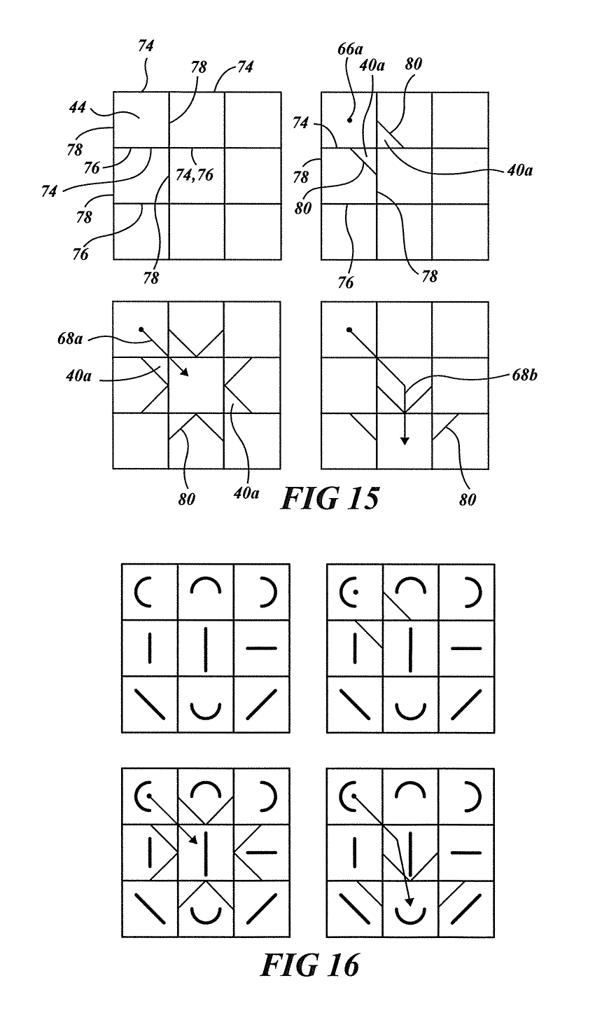

With reference to FIGS. 15 and 16, changing from the first border profile to the second border profile in response to the touch by the user is shown. Specifically, the arraignment of the plurality of touch zones begins with the first border profile of the zones enclosing the series of rectangle shaped areas 44 arraigned in a series of columns and rows. Each rectangle shaped area 44 is defined by a top border 74, a bottom border 76, and side borders 78. The side borders 78 are generally perpendicular to the top border 74 and the bottom border 76. In the illustrated example, the electronic control unit 22 determines that the user is touching the zone defined by the rectangle shapes area 44 in the upper left corner of the grid at start point 66a.

While the user is touching the zone, the electronic control unit 22 alters the first border profile to the second border profile for zones to the side and below the zone being touched. The second border profile in the illustrated example includes the top border 74, the bottom border 76, side borders 78 and angled borders 80. The inclusion of the angled borders 80 alters the rectangle shaped area into a generally rectangular with at least one chamfered corner shaped area 84. The triangle shaped area 40a excluded from the zone by the addition of the angled border 80 is a dead zone, and as such is not associated with any basic shape. The triangle shaped dead zones 40a provide a path for the user to slide their finger to a diagonally located zone without touching the zone to the top, bottom or side.

As the user slides their finger, the electronic control unit is configured to continuously determine what zone the user is touching, and to alter the border profiles of the plurality of zones accordingly. As an extension of the above example, when the electronic control unit 22 determines the user slides their finger from the zone in the upper left corner to the zone in the center along line 68a, the electronic control unit 22 alters border profile for the zones above, below, and to the sides of the center zone to the second border profile including the angled borders 80, thereby created multiple triangle shaped dead zones 40a to provide pathway for the user to slide to the diagonally located zones.

The electronic control unit 22 is further configured to return an altered zone, or one having the second border profile, back to its original shape, or back to the first profile, when the electronic control unit determines such zone is no longer in a position that need to be altered relative to the location of the touch of the user. In continuation of the above example, when the electronic control unit determines the user slides from the center zone to the bottom center zone along line 68b, the electronic control unit 22 alters the border profile of the zones to the top and sides of the previously touched center profile back to the first profile rectangular shaped area 44 define exclusively by the top border 74, the bottom border 76, and side borders 78. Additionally, the electronic control unit 22 alters the first border profile of the zones above and to the sides of the bottom center zone to the second border profile including the angled borders 80, thereby created multiple triangle shaped dead zones 40a to provide pathway for the user to slide to the diagonally located zones.

Not all borders and dead zones in the Figs. have been specifically pointed out with reference numbers and lead lines. It is understood and appreciated that features that appear similar through the figures are similar in nature despite only one or a few have been specially pointed out

A method for entering an alphanumeric character into a computing device is illustrated in FIG. 17 and includes providing a database containing basic shape combination correlated with alphanumeric characters displaying a plurality of basic shapes, step S1; selecting a combination of basic shapes of the displayed plurality of basic shapes, step S2; and identifying which alphanumeric character is associated with the selected combination of basic shapes, step S3. The method may further include displaying the identified alphanumeric character, step S4.

To practice the method an electronic control unit in communication with a touch input device and a display screen, the electronic control unit storing the database containing basic shape combinations correlated with alphanumeric characters, such as that discussed above may be provided, step S0.

The invention is not restricted to the illustrative examples described above. Examples described are not intended to limit the scope of the invention. Changes therein, other combinations of elements, and other uses will occur to those skilled in the art. The scope of the invention is defined by the scope of the claims.

Having described our invention, I claim:

1. A computing device comprising:
an electronic control unit;
a touch input device in communication with the electronic control unit;
a display screen in communication with the electronic control unit;
a database stored in the electronic control unit, the database containing basic shape combinations correlated with alphanumeric characters; and
the electronic control unit configured to identify a plurality of zones on the touch input device with at least some of the zones associated with a basic shape, the electronic control unit further configured to determine when a user has input one of the basic shape combinations with the touch input device and identify from the database the alphanumeric character correlated with the input basic shape combination, and the electronic control unit also configured to instruct the screen display to display the correlated alphanumeric character.

2. The computing device of claim 1 wherein at least some zones of the plurality of zones are defined by a series generally pie shaped areas arraigned in a circle.

3. The computing device of claim 2 wherein the series of generally pie shaped areas arraigned in a circle include a dead spot at the center of the circle.

4. The computing device of claim 1 wherein at least some zones of the plurality of zones are defined by a series of rectangle shapes areas arraigned in columns and rows.

5. The computing device of claim 4 wherein the electronic control unit is configured to alter the shape of rectangular shaped zones adjacent a zone being touched be the user.

6. The computing device of claim 5 wherein the altered shaped of the rectangular shaped zones adjacent the zone being touched by the user is a generally rectangular shape with at least one chamfered corner.

7. The computing device of claim 4 wherein the electronic control unit is further configured to instruct the screen display to a second correlated alphanumeric character when the user slides out of one of the plurality of zones at a predetermined side and then slides back into the one of the plurality of zones.

8. The computing device of claim 1 wherein the touch input device and the display screen are integrated into a touch screen display.

9. A computing device comprising:
an electronic control unit;
a touch input device in communication with the electronic control unit;
a display screen in communication in communication with the electronic control unit; and
the electronic control unit configured to identify a plurality of zones on the touch input device, at least some of the zones of the plurality of zones defined a first border profile, the electronic control unit further configured to determine when a user is touching one of the plurality of zones and to change the first border profile to a second border profile for at least some zones of the zones adjacent the zone being touched by the user.

10. The computing device of claim 9 wherein the first border profile of at least some zones of the plurality of zones is rectangular in shape.

11. The computing device of claim 10 wherein the second border profile at least some zones of the plurality of zones is a generally rectangular shape with at least one chamfered corner.

12. The computing device of claim 9 further comprising:
a database stored in the electronic control unit, the database containing basic shape combinations correlated with alphanumeric characters; and
the electronic control unit configured to associate each zone of the plurality of zones with a basic shape, the electronic control unit further configured to determine when a user has input one of the basic shape combinations with the touch input device and identify from the database the alphanumeric character correlated with the input basic shape combination, and the electronic control unit also configured to instruct the screen display to display the correlated alphanumeric character;
wherein a user inputs the basic shape combination by touching down in one of the plurality of zones, and slides to at least one more other zones of the plurality of zones before lifting up.

13. The computing device of claim 9 wherein the touch input device and the display screen are integrated into a touch screen display.

14. A method for entering an alphanumeric character into a computing device comprising:
providing a database containing basic shape combination correlated with alphanumeric characters displaying a plurality of basic shapes;
selecting a combination of basic shapes of the displayed plurality of basic shapes; and
identifying which alphanumeric character is associated with the selected combination of basic shapes.

15. The method of claim 14 further comprising:
displaying the identified alphanumeric character.

16. The method of claim 15 further comprising:
providing an electronic control unit in communication with a touch input device and a display screen, the electronic control unit storing the database containing basic shape combinations correlated with alphanumeric characters;
wherein the plurality of basic shapes is displayed on the touch input device, the selected combination is selected with the touch input device, the alphanumeric character is identified by the electronic control unit, and the identified alphanumeric character is displayed on the display screen.

17. The method of claim 14 wherein the basic shapes are displayed in a series of columns and rows.
